(19) United States
(12) Patent Application Publication
(10) Pub. No.: US 2023/0297899 A1
(43) Pub. Date: Sep. 21, 2023

(54) Optimal Time-to-Event Modeling for Longitudinal Prediction fo Open Entitles

(71) Applicant: Google LLC, Mountain View, CA (US)

(72) Inventors: Jingtao Wang, Pittsburgh, PA (US); Wangyang Zhang, Allison Park, PA (US); Michael Peter Perrone, Yorktown Heights, NY (US)

(73) Assignee: Google LLC, Mountain View, CA (US)

(21) Appl. No.: 18/183,291

(22) Filed: Mar. 14, 2023

Related U.S. Application Data
(60) Provisional application No. 63/320,632, filed on Mar. 16, 2022.

(51) Int. Cl. G06Q 10/04

(52) U.S. Cl. CPC G06Q 10/04

(57) ABSTRACT

A method for optimal time-to-event (TTE) modeling includes obtaining a forecast request requesting performance of a TTE forecast forecasting an amount of time an event will occur after a starting point in time. The method includes obtaining a cutoff value representing an amount of time after the starting point in time that the event has not occurred. The method also includes forecasting, using an uncertainty forecasting model, the amount of time the event will occur after the starting point in time and updating the forecasted amount of time based on the cutoff value. The method also includes returning the updated forecasted amount of time the event will occur after the starting point in time.

### CROSS REFERENCE TO RELATED APPLICATIONS

This U.S. patent application claims priority under 35 U.S.C. §119(e) to U.S. Provisional Application 63/320,632, filed on Mar. 16, 2022. The disclosure of this prior application is considered part of the disclosure of this application and is hereby incorporated by reference in its entirety.

### TECHNICAL FIELD

This disclosure relates to optimal time-to-event modeling for longitudinal prediction of open entities.

### BACKGROUND

Time-to-Event (TTE) modeling predicts the time at which an event-of-interest (EOI) occurs and is a crucial task in enterprise machine learning. Sample applications of TTE modeling include predicting the settlement date of an invoice, forecasting the delivery time of a package, predicting the failure date of a tensor processing unit (TPU), and predicting the discharge date of a hospitalized patient.

### SUMMARY

One aspect of the disclosure provides a method for optimal time-to-event (TTE) modeling for longitudinal prediction of open entities. The computer-implemented method, when executed by data processing hardware, causes the data processing hardware to perform operations. The operations include obtaining a forecast request requesting the data processing hardware to perform a time-to-event forecast forecasting an amount of time an event will occur after a starting point in time. The operations also include obtaining a cutoff value representing an amount of time after the starting point in time that the event has not occurred. The operations include forecasting, using an uncertainty forecasting model, the amount of time the event will occur after the starting point in time and updating the forecasted amount of time based on the cutoff value. The operations also include returning the updated forecasted amount of time the event will occur after the starting point in time.

Implementations of the disclosure may include one or more of the following optional features. In some implementations, forecasting the amount of time the event will occur after the starting point in time includes generating, using a machine learning model, an initial probability density function representing a distribution of probabilities of different amounts of times the event will occur after the starting point in time. In some of these implementations, updating the forecasted amount of time based on the cutoff value includes generating a conditional probability density function based on the initial probability density function and the cutoff value. In some of these implementations, generating the conditional probability density function includes using rejection sampling. Optionally, updating the forecasted amount of time based on the cutoff value further includes applying an optimal estimator to the conditional probability density function. The optimal estimator may include an optimal mean average error estimator or an optimal mean squared error estimator.

In some examples, the operations further include, prior to forecasting the amount of time until the event occurs, training the uncertainty forecasting model on a plurality of training samples. Each training sample of the plurality of training samples includes a settled event. In some of these examples, each settled event includes a starting point in time and an ending point in time.

Optionally, the cutoff value is dynamically adjustable. In some implementations, the operations further include, after the starting point in time and before the event has occurred, obtaining an update request requesting the data processing hardware to perform a second time-to-event forecast forecasting the amount of time the event will occur after the starting point in time. In response to receiving the update request, the operations include updating the cutoff value based on an amount of time that has elapsed since obtaining the cutoff value and further updating the updated forecasted amount of time until the event occurs based on the updated cutoff value. The operations may also further include returning the further updated forecasted amount of time the event will occur after the starting point in time.

Another aspect of the disclosure provides a system for optimal time-to-event (TTE) modeling for longitudinal prediction of open entities. The system includes data processing hardware and memory hardware in communication with the data processing hardware. The memory hardware stores instructions that when executed on the data processing hardware cause the data processing hardware to perform operations. The operations include obtaining a forecast request requesting the data processing hardware to perform a time-to-event forecast forecasting an amount of time an event will occur after a starting point in time. The operations also include obtaining a cutoff value representing an amount of time after the starting point in time that the event has not occurred. The operations include forecasting, using an uncertainty forecasting model, the amount of time the event will occur after the starting point in time and updating the forecasted amount of time based on the cutoff value. The operations also include returning the updated forecasted amount of time the event will occur after the starting point in time.

This aspect may include one or more of the following optional features. In some implementations, forecasting the amount of time the event will occur after the starting point in time includes generating, using a machine learning model, an initial probability density function representing a distribution of probabilities of different amounts of times the event will occur after the starting point in time. In some of these implementations, updating the forecasted amount of time based on the cutoff value includes generating a conditional probability density function based on the initial probability density function and the cutoff value. In some of these implementations, generating the conditional probability density function includes using rejection sampling. Optionally, updating the forecasted amount of time based on the cutoff value further includes applying an optimal estimator to the conditional probability density function. The optimal estimator may include an optimal mean average error estimator or an optimal mean squared error estimator.

In some examples, the operations further include, prior to forecasting the amount of time until the event occurs, training the uncertainty forecasting model on a plurality of training samples. Each training sample of the plurality of training samples includes a settled event. In some of these examples, each settled event includes a starting point in time and an ending point in time.

Optionally, the cutoff value is dynamically adjustable. In some implementations, the operations further include, after the starting point in time and before the event has occurred, obtaining an update request requesting the data processing hardware to perform a second time-to-event forecast forecasting the amount of time the event will occur after the starting point in time. In response to receiving the update request, the operations include updating the cutoff value based on an amount of time that has elapsed since obtaining the cutoff value and further updating the updated forecasted amount of time until the event occurs based on the updated cutoff value. The operations may also further include returning the further updated forecasted amount of time the event will occur after the starting point in time.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for forecasting a time-to-event using longitudinal prediction.

FIG. 2 is a schematic view of exemplary longitudinal open entities.

FIG. 3 is a schematic view of an exemplary initial probability density function and a conditional probability density function.

FIG. 4 is a schematic view of exemplary optimal estimators.

FIG. 5 is a schematic view of a causal graph for the system of FIG. 1.

FIG. 6 a flowchart of an example arrangement of operations for a method of forecasting a time-to-event using longitudinal prediction.

FIG. 7 is a schematic view of an example computing device that may be used to implement the systems and methods described herein.

Like reference symbols in the various drawings indicate like elements.

### DETAILED DESCRIPTION

Time-to-Event (TTE) modeling predicts the time at which an event-of-interest (EOI) occurs and is a crucial task in enterprise machine learning. Sample applications of TTE modeling include predicting the settlement date of an invoice, forecasting the delivery time of a package, predicting the failure date of a tensor processing unit (TPU), and predicting the discharge date of a hospitalized patient.

Conventional techniques for TTE modeling or prediction use regression models. However, the typical use cases of TTE modeling such as predicting open entities (e.g., subset of active orders/invoices) longitudinally imposes unique challenges to the formulation, model training, inference, and evaluation of TTE models. Specifically, a “vanilla” regression model is no longer appropriate because conditional distributions introduced by the implicit filtering action on a variable cutoff time play a critical role. Modeling such use cases with state-of-the-art regressors (e.g. AutoML Regression, Boosted Tree Regression, etc.) can introduce a large underestimation bias. Thus, forecasting open entities longitudinally breaks multiple implicit assumptions of classic machine learning (ML). More particularly, regression-based TTE modeling is appropriate when only a single prediction is made at a time when an entity is created. For the use case of predicting open entities at a specific point in time longitudinally (i.e., at a point in time after when the entity is created), the signals carried by the time that has elapsed (i.e., a “cutoff time”) will cause systemic underestimation bias for vanilla regressors.

Implementations herein provide a TTE forecaster that provides an unbiased optimal prediction for TTE open entities longitudinally by accounting for the cutoff time, thereby providing a significant improvement over regression models which are prone to producing large underestimation biases. The TTE forecaster generates an uncertainty forecast (e.g., a probability density function) and a “Monty Hall” estimator to generate an optimal TTE estimation for open entities created on or before cutoff time.

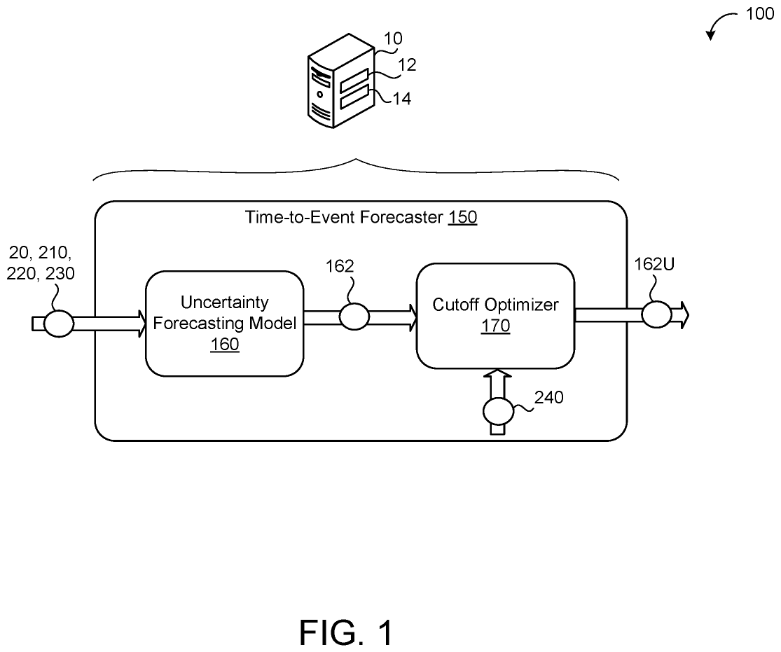

Referring now to FIG. 1, in some implementations, an example system 100 includes a processing system 10. The processing system 10 may be a single computer, multiple computers, a user device (e.g., a smart phone, a tablet, a laptop, etc.), or a distributed system (e.g., a cloud computing environment) having fixed or scalable/elastic computing resources 12 (e.g., data processing hardware) and/or storage resources 14 (e.g., memory hardware). The processing system 10 executes a time-to-event (TTE) forecaster 150. The TTE forecaster 150 obtains or receives (e.g., from a user using or in communication with the processing system 10, from a remote server via a network, from another module or application executing on the processing system 10, etc.) a forecast request 20 requesting the TTE forecaster 150 to forecast an amount of time an event 210 will occur after a starting point in time 220. For example, the request 20 requests that the TTE forecaster 150 forecast or predict the discharge date (i.e., the event 210) of a hospitalized patient based on the admittance date (i.e., the starting point in time 220) of the patient. Optionally, the request 20 includes an end point in time 230. For example, the request 20 requests that the TTE forecaster 150 forecast or predict a settlement date (i.e., the event 210) of an invoice based on the date the invoice was submitted (i.e., the starting point in time 220) and the date that the invoice is due (i.e., the end point in time 230).

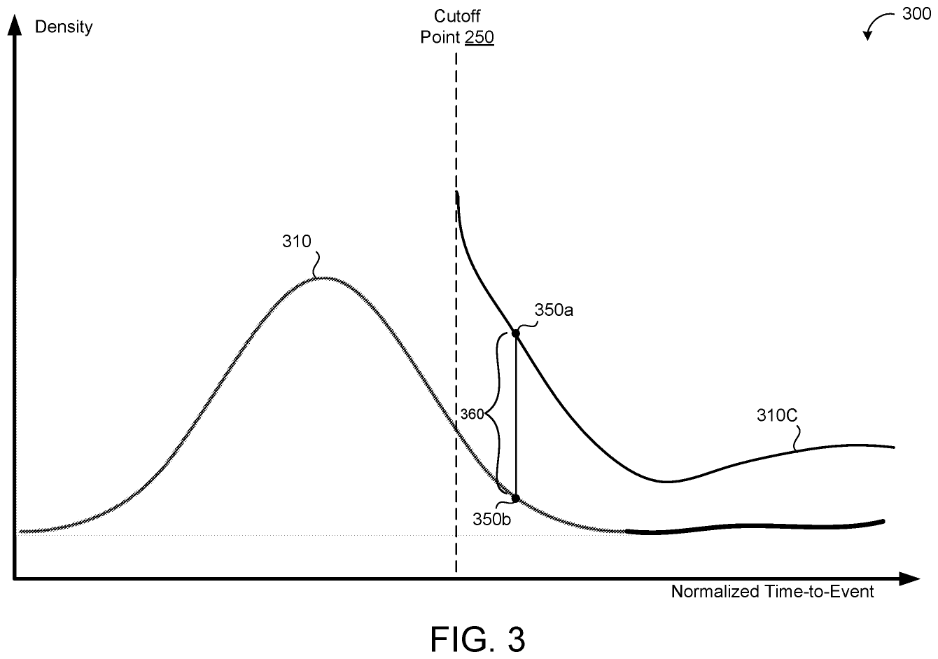

The TTE forecaster 150 includes an uncertainty forecasting model 160. The uncertainty forecasting model 160 forecasts or predicts the amount of time 162 (also referred to herein as a forecast 162) the event 210 will occur after the starting point in time 220. In some examples, the uncertainty forecasting model 160 is a machine learning (ML) model. The uncertainty forecasting model 160 may forecast the amount of time 162 using techniques such as quantile regression, survival analysis, kernel density estimation, or any other known techniques. In some examples, the amount of time 162 forecasted or predicted by the uncertainty forecasting model 160 is represented by an initial probability density function (PDF) 310 (FIG. 3). In these examples, the initial PDF 310 of the amount of time 162 represents a distribution of probabilities of different amounts of times the event will occur after the starting point in time 220. For example, the TTE forecaster 150 selects the date with the highest probability as the amount of time 162 based on the initial PDF.

The TTE forecaster 150, in some examples and prior to forecasting the amount of time 162 until the event 210 occurs, trains the uncertainty forecasting model 160 on a plurality of training samples. Each training sample includes a settled event. For example, the training samples include start dates, end dates, and/or settlement dates for events 210.

The TTE forecaster 150 also includes a cutoff optimizer 170. The cutoff optimizer 170 obtains a cutoff value 240. The cutoff value 240 represents an amount of time after the starting point in time 220 that the event 210 has not occurred. For example, when the TTE forecaster 150 is to forecast the settlement date of an invoice and the starting point in time 220 is January 1^{st} (i.e., the date the invoice was issued), on January 5^{th}, the cutoff value 240 is five days because five days have elapsed without the event 210 occurring (i.e., the invoice settling). The use of days is purely exemplary, and any units of time may be used (e.g., seconds, minutes, hours, etc.). Notably, the cutoff value 240 is not used to train the uncertainty forecasting model 160, as use during training leads to a biased/skewed prediction and would require additional resampling/debiasing transformations resulting in the need to perform frequent model retraining. The cutoff value 240 is dynamically adjustable. That is, the cutoff value 240 may be repeatedly changed to different values to affect the forecast. In some examples, the TTE forecaster 150 obtains the cutoff value 240 from the request 20 (e.g., from a user). In other examples, the TTE forecaster 150 automatically determines the cutoff value 240 based on the starting point in time 220 and a current time or a time the request 20 was received.

As discussed in more detail below, the cutoff optimizer 170, using the cutoff value 240, updates the forecasted amount of time 162 to determine an updated or optimal forecasted amount of time 162, 162U. In some examples, the updated amount of time 162U is represented by a conditional PDF 310C. In these examples, the conditional PDF 310C of the updated amount of time 162U represents an updated distribution of probabilities of different amounts of times the event will occur after the starting point in time 220. The cutoff optimizer 170 generates the conditional PDF 310C based on the initial PDF 310 and the cutoff value 240. Thus, while the amount of time 162 determined by the uncertainty forecasting model 160 reflects a forecast for the settlement date of the event 210 at the starting point in time 220, the cutoff optimizer 170 updates the amount of time 162 to reflect the changes in probability that have occurred in additional time passing since the starting point in time 220 without the event 210 occurring.

The TTE forecaster 150 returns the updated forecasted amount of time 162U (e.g., to the user associated with the request 20). For example, the TTE forecaster 150 returns the updated forecasted amount of time 162U to the entity that generated the request 20 (e.g., a user or another system). In some examples, the TTE forecaster 150 automatically (e.g., per a schedule) performs regular forecasts for open entities (i.e., events 210 that have not yet occurred) based on updated cutoff values 240 (e.g., based on the amount of time that has elapsed since the forecast). For example, the TTE forecaster 150, when forecasting a settlement date for an invoice, generates an updated forecast 162U each day using a new cutoff value 240 that reflects the additional day that has passed without the event 210 occurring since the previous forecast. This allows the TTE forecaster 150 to leverage the information provided by the additional time passing without the event 210 occurring to increase the accuracy of the forecasts 162.

In some implementations, the TTE forecaster 150 repeatedly, at regular or irregular intervals, updates updated forecasted amount of time 162U based on new or updated cutoff values 240. For example, the TTE forecaster 150 obtains an update request requesting a second time-to-event forecast forecasting the amount of time the event 210 will occur after the starting point in time 220. In response to receiving the update request, the TTE forecaster 150 updates the cutoff value 240 based on an amount of time that has elapsed since obtaining the original or initial cutoff value 240 and further updates the updated forecasted amount of time 162U until the event 210 occurs based on the updated cutoff value 240. The TTE forecaster 150 then returns the further updated forecasted amount of time 162U the event 210 will occur after the starting point in time 220. In this way, the TTE forecaster 150 may regularly update the forecast for open entities with increasingly accurate predictions. For example, an invoicing system may generate a forecast for each open entity (e.g., open invoice) once a day (or at any other regular or irregular interval). That is, even with no other change other than a day passing without the event occurring, the TTE forecaster 150 can provide a more accurate forecast using the cutoff value 240. Notably, once an event 210 occurs, forecasts are no longer needed and can be removed from the schedule (i.e., the TTE forecaster 150 need not forecast for closed entities). The TTE forecaster 150 can automatically (i.e., without human intervention) update and refine forecasts 162U for all open entities 202 based on a schedule or other triggering events.

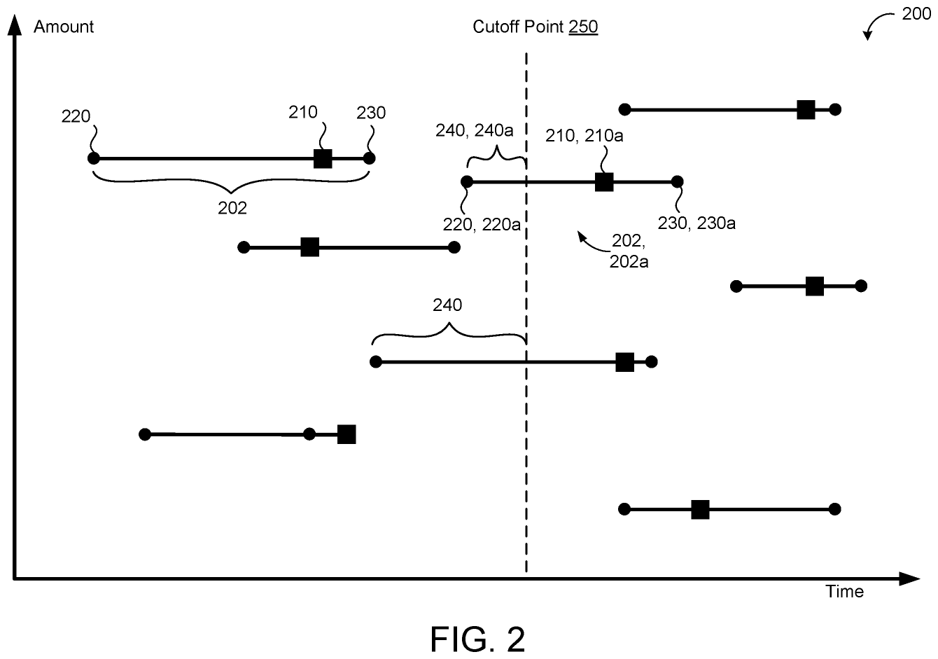

Referring now to FIG. 2, a schematic view 200 includes a graph or plot of multiple open entities 202. Each entity 202 includes the event 210 which the TTE forecaster 150 is to forecast, the starting point in time 220 and the end point in time 230.

For example, when the entities 202 are associated with invoices, the x-axis represents time, the y-axis represents an amount of the invoice, the starting point in time 220 represents a date the invoice is issued, the end point in time 230 represents the date the invoice is due, and the event 210 represents the settlement date of the invoice. Predicting open entities repetitively breaks multiple assumptions of classic machine learning. As a result, this use case present unique challenges to the formulation, training, inference, and evaluation of machine learning models. This particular use case raises two interesting properties. First, multiple predictions can be generated after the creation of an entity 202 but prior to the event occurring (i.e., for “open” entities). Second, future predictions are no longer needed once the event 210 for a given entity 202 occurs. In such use cases, conventional regression models are no longer appropriate because doing so will lead to a significant underestimate bias.

In this example, a first entity 202, 202a for a first event 210, 210a has a first starting point in time 220, 220a and a first end point in time 230, 230a. A cutoff point 25 (i.e., the dashed line) occurs at a point where the entity 202a is open (i.e., after the starting point in time 220a but before the event 210a occurs). The cutoff point 250 demarcates a point in time after the starting point in time 220 that represents the cutoff value 240. Here, the cutoff point 250 and the starting point in time 220a establish the cutoff time 240a. The cutoff time 240a represents an amount of time since the starting point in time 220a where the event 210a has not occurred. In some examples, the cutoff point 250 is the current time and in these examples, the cutoff value 240 is the amount of time that has elapsed between the current time and the starting point in time 220.

Referring now to FIG. 3, a schematic view 300 includes a plot of an exemplary initial PDF 310 (representing the amount of time 162) generated by the uncertainty forecasting model 160. The y-axis represents the density or the probability of the event 210 occurring while the x-axis represents a normalized time until the event occurs. In this example, a cutoff point 250 establishes a point along the initial PDF 310 where the event 210 has yet to occur. The plot includes a conditional PDF 310C (representing the updated amount of time 162U) that begins from the cutoff point 250 and continues to the right as time passes. As can be seen from a point 350a on the conditional PDF and a point 350b on the initial PDF at the same point in time, there is a considerable offset 360 between the probabilities that represents the underestimate bias present in conventional modeling techniques. In some examples, the TTE forecaster 150 generates the conditional PDF (i.e., the updated amount of time 162U) by using rejection sampling (i.e., acceptance-rejection) with t<cutoff as the rejection condition.

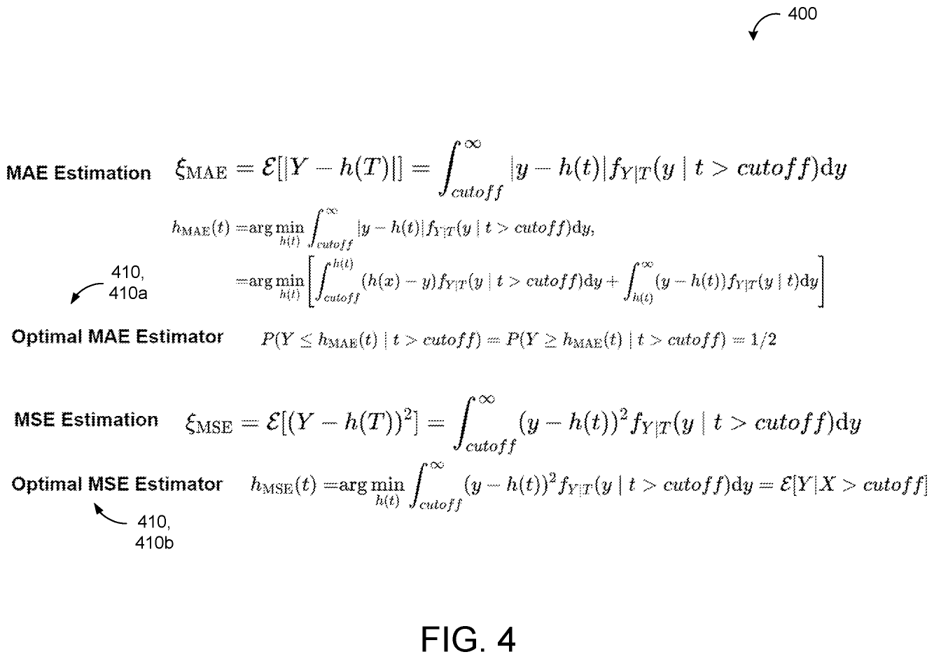

Referring now to FIG. 4, a schematic view 400 includes exemplary optimal “Monty Hall” estimators 410. Specifically, FIG. 4 demonstrates both a mean absolute error (MAE) estimator 410, 410a and a mean squared error (MSE) estimator 410, 410b. Other estimators are possible, such as a binary loss estimator 410. In some implementations, after generating the conditional PDF 310C using rejection sampling, the TTE forecaster 150 applies an estimator 410, such as the MAE estimator 410a or the MSE estimator 410b of FIG. 4, to the conditional PDF 310C to determine the updated amount of time 162U. The TTE forecaster 150 may select an appropriate estimator 410 based on use case and/or identified evaluation metrics. For example, when evaluation metrics determine that it is optimal to base predictions on whether the event 210 occurs on a given date, the date that maximizes the conditional PDF 310C, a binary loss estimator 410 is appropriate. In another example, when evaluation metrics value a minimal average difference (i.e., mean absolute error) between the predicted amount of time 162 and the actual time of the event 210, the MAE estimator 410a is optimal. In yet another example, when the evaluation metrics value a minimal average squared difference between the predicted amount of time 162 and the actual time of the event 210, the MSE estimator 410b is optimal.

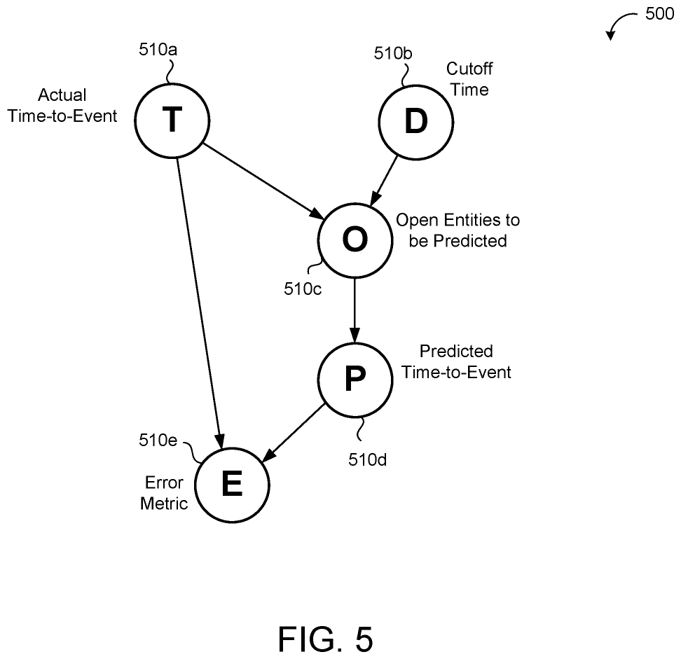

Referring now to FIG. 5, a causal graph 500 models the information flow for the TTE forecaster 150 that reveals the descriptive yet counterintuitive cutoff feature. Here, the collider node enables “information flow” between two originally independent nodes (i.e., node 510a and node 510b). This provides a causal connection between TTE modeling and Monty Hall problems. That is, like in the Monty Hall problem, the intuitive belief that the initial probability is not affected as time passes without the event occurring (mirroring the intuitive belief that the probability that the correct door was selected after revealing another door in the original Monty Hall problem) is incorrect.

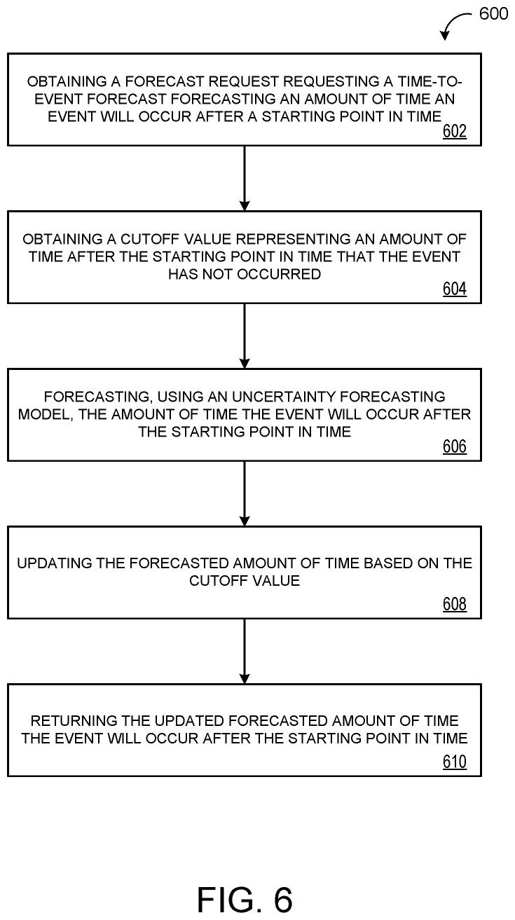

FIG. 6 is a flowchart of an exemplary arrangement of operations for a method 600 for generating time-to-event forecasts. The method 600, at operation 602, includes obtaining a forecast request 20 requesting the data processing hardware 12 to perform a time-to-event forecast an amount of time 162 an event 210 will occur after a starting point in time 220. The method 600, at operation 604, includes obtaining a cutoff value 240 representing an amount of time after the starting point in time 220 that the event 210 has not occurred. At operation 606, the method 600 includes forecasting, using an uncertainty forecasting model 160, the amount of time 162 the event 210 will occur after the starting point in time 220. At operation 608, the method 600 includes updating the forecasted amount of time 162 until the event 210 occurs based on the cutoff value 240. The method 600, at operation 610, includes returning the updated forecasted amount of time 162U the event 210 will occur after the starting point in time 220.

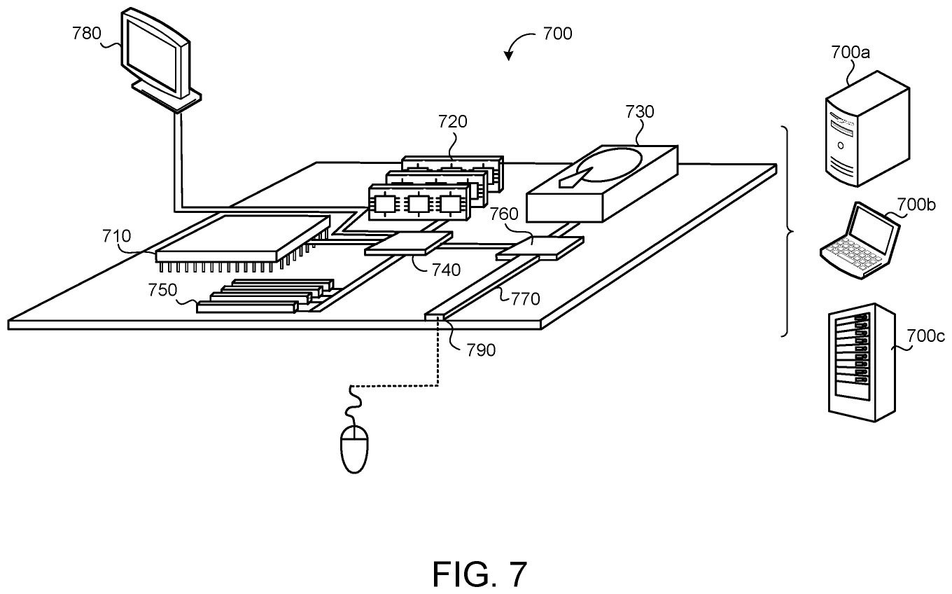

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
obtaining a forecast request requesting the data processing hardware to perform a time-to-event forecast forecasting an amount of time an event will occur after a starting point in time;
obtaining a cutoff value representing an amount of time after the starting point in time that the event has not occurred;
forecasting, using an uncertainty forecasting model, the amount of time the event will occur after the starting point in time;
updating the forecasted amount of time based on the cutoff value; and
returning the updated forecasted amount of time the event will occur after the starting point in time.

2. The method of claim 1, wherein forecasting the amount of time the event will occur after the starting point in time comprises generating, using a machine learning model, an initial probability density function representing a distribution of probabilities of different amounts of times the event will occur after the starting point in time.

3. The method of claim 2, wherein updating the forecasted amount of time based on the cutoff value comprises generating a conditional probability density function based on the initial probability density function and the cutoff value.

4. The method of claim 3, wherein generating the conditional probability density function comprises using rejection sampling.

5. The method of claim 3, wherein updating the forecasted amount of time based on the cutoff value further comprises applying an optimal estimator to the conditional probability density function.

6. The method of claim 5, wherein the optimal estimator comprises:
an optimal mean average error estimator; or an optimal mean squared error estimator.

7. The method of claim 1, wherein the operations further comprise, prior to forecasting the amount of time until the event occurs, training the uncertainty forecasting model on a plurality of training samples, each training sample of the plurality of training samples comprising a settled event.

8. The method of claim 7, wherein each settled event comprises the starting point in time and an ending point in time.

9. The method of claim 1, wherein the cutoff value is dynamically adjustable.

10. The method of claim 1, wherein the operations further comprise, after the starting point in time and before the event has occurred:
obtaining an update request requesting the data processing hardware to perform a second time-to-event forecast forecasting the amount of time the event will occur after the starting point in time;
in response to receiving the update request, updating the cutoff value based on an amount of time that has elapsed since obtaining the cutoff value;
further updating the updated forecasted amount of time until the event occurs based on the updated cutoff value; and
returning the further updated forecasted amount of time the event will occur after the starting point in time.

11. A system comprising:
data processing hardware; and
memory hardware in communication with the data processing hardware, the memory hardware storing instructions that when executed on the data processing hardware cause the data processing hardware to perform operations comprising:
obtaining a forecast request requesting the data processing hardware to perform a time-to-event forecast forecasting an amount of time an event will occur after a starting point in time;
obtaining a cutoff value representing an amount of time after the starting point in time that the event has not occurred;
forecasting, using an uncertainty forecasting model, the amount of time the event will occur after the starting point in time;
updating the forecasted amount of time based on the cutoff value; and
returning the updated forecasted amount of time the event will occur after the starting point in time.

12. The system of claim 11, wherein forecasting the amount of time the event will occur after the starting point in time comprises generating, using a machine learning model, an initial probability density function representing a distribution of probabilities of different amounts of times the event will occur after the starting point in time.

13. The system of claim 12, wherein updating the forecasted amount of time based on the cutoff value comprises wherein updating the forecasted amount of time based on the cutoff value comprises generating a conditional probability density function based on the initial probability density function and the cutoff value.

14. The system of claim 13, wherein generating the conditional probability density function comprises using rejection sampling.

15. The system of claim 13, wherein updating the forecasted amount of time based on the cutoff value further comprises applying an optimal estimator to the conditional probability density function.

16. The system of claim 15, wherein the optimal estimator comprises:
an optimal mean average error estimator; or
an optimal mean squared error estimator.

17. The system of claim 11, wherein the operations further comprise, prior to forecasting the amount of time until the event occurs, training the uncertainty forecasting model on a plurality of training samples, each training sample of the plurality of training samples comprising a settled event.

18. The system of claim 17, wherein each settled event comprises the starting point in time and an ending point in time.

19. The system of claim 11, wherein the cutoff value is dynamically adjustable.

20. The system of claim 11, wherein the operations further comprise, after the starting point in time and before the event has occurred:
obtaining an update request requesting the data processing hardware to perform a second time-to-event forecast forecasting the amount of time the event will occur after the starting point in time;
in response to receiving the update request, updating the cutoff value based on an amount of time that has elapsed since obtaining the cutoff value;
further updating the updated forecasted amount of time until the event occurs based on the updated cutoff value; and
returning the further updated forecasted amount of time the event will occur after the starting point in time.
